(19) United States
(12) Patent Application Publication
(10) Pub. No.: US 2007/0184215 A1
(43) Pub. Date: Aug. 9, 2007

(54) Material for forming images by inkjet printing

(75) Inventor: Didier J. Martin, Givry (FR)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/348,652

(22) Filed: Feb. 7, 2006

(51) Int. Cl. B41M 5/00

(52) U.S. Cl. 428/32.1

(57) ABSTRACT

The present invention relates to a material intended for forming images by inkjet printing having good stability to ozone and to light as well as a uniform surface, to obtain a high-quality printed image. The material comprises a support and at least one ink-receiving layer, wherein the ink-receiving layer comprises at least one carrageenan and at least one polymer comprising hydroxyl groups. Preferably, the carrageenan is selected from among the group comprising the κ-carrageenans, the ι-carrageenans or a combination of these compounds.

### CROSS REFERENCE TO RELATED APPLICATIONS

Reference is made to commonly assigned, co-pending U.S. patent applications:
Ser. No. ______ by Didier Martin (Docket 88478) filed of even date herewith entitled “COATING METHOD OF MATERIAL FOR INKJET PRINTING”;
Ser. No. ______ by Didier Martin (Docket 88479) filed of even date herewith entitled “POLYSACCHARIDE MATERIALS WITH HYDROXYLATED POLYMERS IN INK RECEIVING MEDIA”; and
Ser. No. ______ by Didier Martin (Docket 86918) filed of even date herewith entitled “MATERIAL FOR FORMING IMAGES BY INKJET PRINTING”; and
Ser. No. ______ by Didier Martin (Docket 91932) filed of even date herewith entitled “GELS OF POLYSACCHARIDE, FLUORINATED SURFACTANT AND PARTICLES”, the disclosures of which are incorporated herein by reference.

### FIELD OF THE INVENTION

The present invention relates to a material intended for forming images by inkjet printing.

### BACKGROUND OF THE INVENTION

Digital photography has been growing fast for several years and the general public now has access to efficient and reasonably-priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced through one or more nozzles so that the ink is transformed into a flow of droplets. In order to obtain the most regular sizes and spacing between drops, regular pressure pulses are sent using, for example, a piezoelectric crystal in contact with the ink with high frequency (up to 1 MHz) alternating current (AC) power supply. So that a message can be printed using a single nozzle, every drop must be individually controlled and directed. Electrostatic energy is used for this purpose: an electrode is placed around the ink jet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of the plates. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the basis of inkjet printers used in office automation. With this method, the pressure in the ink cartridge is not maintained constant but is applied when a character has to be formed. In one widely used system, there is a row of twelve open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps the ink necessary for new printings into the reservoir. The row of nozzles is thus used to generate a column matrix, so that no deflection of the drop is necessary. One variation of this system replaces the piezoelectric crystals by small heating elements behind each nozzle. The drops are ejected following the forming of bubbles of solvent vapor. The volume increase enables the expulsion of the drop.

Finally, there is a pulsed inkjet system in which the ink is solid at ambient temperature. The print head thus has to be heated so that the ink liquefies and can print. This enables rapid drying on a wider range of products than conventional systems.

New “inkjet” printers capable of producing photographic images of excellent quality are now available. However, they cannot supply good proofs if inferior quality printing paper is used. The choice of printing paper is fundamental for the quality of the resulting image. The printing paper must combine the following properties: high-quality printed image, rapid drying during printing, good image colorfastness over time, and smooth and glossy appearance.

In general, the printing paper comprises a support coated with one or more layers according to the properties required. It is possible, for example, to apply on a support an etch primer layer, an absorbent layer, an ink dye fixing layer and a protective layer or surface layer to provide the gloss of the material. The absorbent layer absorbs the liquid part of the water-based ink composition after creation of the image. Elimination of the liquid reduces the risk of ink migration to the surface. The ink dye fixing layer prevents any dye loss into the fibers of the paper base, to obtain good color saturation while preventing excess ink that would encourage the increase in size of the printing dots and therefore reduce image quality. The absorbent layer and fixing layer can also constitute a single ink-receiving layer accomplishing both functions. The protective layer is designed to ensure protection against fingerprints and the pressure marks of the printer feed rollers.

The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal boehmite) marketed by Sasol. However, printing paper comprising an ink-receiving layer containing such inorganic receivers can have poor image stability in time, which is demonstrated by a loss of color density.

Furthermore, especially from U.S. Pat. No. 6,419,987, the use of polyvinyl alcohol as binder in the ink-receiving layer in materials intended for inkjet printing as well as hardeners, such as DHD (dihydroxydioxane) or sodium tetraborate (borax) is well known. The disadvantage of this mixture is that it causes crackle or wavelet phenomena during the drying of the composition intended to form the ink-receiving layer. These phenomena can visibly alter the final quality of the printed image. The use of polyvinyl alcohol thus requires specific coating conditions that do not enable either cost reductions or productivity increases. Furthermore, hardeners can lead to unwanted reactions that result in a residual tint of the ink-receiving layer. Hardeners also tend to migrate, which can cause crosslinking in the surface of the ink-receiving layer, thus obstructing ink absorption.

### PROBLEM TO BE SOLVED

Therefore it is necessary to propose a material intended for inkjet printing having a uniform surface, to obtain a high-quality printed image, a fast drying speed, and good colorfastness of the image over time, in particular demonstrated by good color stability of the printed image to ozone and light, as well as a manufacturing process of said material intended for forming inkjet images enabling improvement of the coating properties of the compositions intended to form the ink-receiving layer so as to obtain the material at lower cost, and at high speeds of production.

### SUMMARY OF THE INVENTION

The new material according to the present invention, intended for forming images by inkjet printing, comprises a support and at least one ink-receiving layer, wherein the ink-receiving layer comprises at least one carrageenan and at least one polymer comprising hydroxyl groups. The present invention also relates to a manufacturing method for a material intended for forming images by inkjet printing as described above, comprising a) heating a composition intended to form an ink-receiving layer, said composition comprising at least one carrageenan and at least one polymer comprising hydroxyl groups, to obtain a solution, b) coating said composition on a support, c) cooling the resulting material to obtain the thermoreversible gelation of the composition, and d) drying the material.

### ADVANTAGEOUS EFFECT OF THE INVENTION

The present invention includes several advantages, not all of which are incorporated in a single embodiment. The use of carrageenan enables the composition used to form the ink-receiving layer to be fixed quickly on the support after coating, while giving it a low enough viscosity at the coating temperature to spread in the coating device. The setting of the composition before its drying enables an ink-receiving layer having great surface uniformity to be obtained. The printed image is thus high-quality. The material according to the invention has good adhesion properties between the receiving layer and the support, making it no longer necessary to use hardeners. The combination of carrageenan and polymer with hydroxyl groups advantageously enables replacement of the gelatin generally used as binder, which has the disadvantage of swelling in contact with ink drops. The use of carrageenan enables conventional coating machines with loop drying at high coating speeds to be used, and thus existing equipment to be made profitable. The method according to the invention enables an ink-receiving layer having great uniformity to be obtained, and thus a high-quality printed image. Furthermore, the use of carrageenan enables the color stability of the printed image to be improved, in particular stability to ozone and to light.

### BRIEF DESCRIPTION OF THE DRAWINGS

FIG. 1 represents the percentage of color density loss for various comparative materials and according to the present invention when exposed to ozone, and

FIG. 2 represents the percentage of color density loss for various comparative materials and according to the present invention when exposed to light.

### DETAILED DESCRIPTION OF THE INVENTION

The present invention relates to a material for use as an inkjet printing receiver which comprises a support and an ink-receiving layer containing a polysaccharide, most preferably carrageenan, and polymer comprising hydroxyl groups. The present invention also relates to a method for manufacturing this material. Preferably, the carrageenan is a k-carrageenan and the polymer comprising the hydroxyl groups is polyvinyl alcohol or guar gum, or a mixture of these polymers.

The material intended for forming images by inkjet printing according to the present invention comprises firstly a support. This support is selected according to the desired use. It can be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and their mixtures. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred as support intended for inkjet printing. The side of the support that is used can be coated with a very thin layer of gelatin or another composition to ensure the adhesion of the first receiving layer on the support. To improve the adhesion of the adhesion layer (layer of gelatin or other composition) on the support, the support surface can also have been subjected to a preliminary treatment by corona discharge before applying the adhesion layer.

In accordance with the invention, the material intended for forming images by inkjet printing comprises at least one hydrophilic ink-receiving layer, said ink-receiving layer comprising at least one hydrophilic polysaccharide, most preferably carrageenan, and at least one hydrophilic polymer comprising hydroxyl groups.

Carrageenan is typically made from dried extracts of red seaweed (rhodophyceae). Carrageenans are linear polysaccharides made up of more or less substituted galactose residues. The chain is made up of subunits called carrabioses comprising two galactose residues bound by a b (1-4) linkage. These carrabioses are bound together in the chain by a (1-3) linkages. Furthermore, the galactose residues are either esterified by sulfuric acid, or have an oxygen bridge between carbons 3 and 6. Carrageenans are polymers made up of more than 1000 galactose residues. There are three main types of carrabiose: k-carrabiose, i-carrabiose, and l-carrabiose, corresponding to the three main types of carrageenans: k-carrageenan, a polysaccharide made up of n units of k-carrabiose, i-carrageenan, a polysaccharide made up of n units of i-carrabiose, and l-carrageenan, a polysaccharide made up of n units of l-carrabiose.

According to the present invention, the carrageenan is selected from among the group including the k-carrageenans, the i-carrageenans or a mixture of these compounds. Preferably, the carrageenan comprises at least 80% k-carrageenan. According to an especially preferred variant, carrageenan is a pure k-carrageenan. Carrageenan acts as a gelating agent enabling thermoreversible gelation of the composition intended to form the ink-receiving layer.

According to the invention, the ink-receiving layer comprises at least one polymer comprising hydroxyl groups. The polymer is most desirably water soluble and/or hydrophillic. Preferably, the polymer comprising the hydroxyl groups is selected from among the group including polyvinyl alcohol and guar gum, or a mixture of these polymers. The polymer comprising the hydroxyl groups enables the syneresis phenomena to be controlled to form a film as a gel without crystallization phenomena, even after the drying phase.

In a particularly advantageous way, the combination of carrageenan with guar gum enables a satin ink-receiving layer to be obtained, while the combination of carrageenan with polyvinyl alcohol enables a glossy ink-receiving layer to be obtained.

The ink-receiving layer preferably includes less than 1% by weight of polysaccharide, for example, carrageenan, compared with the total weight of the wet receiving layer. Preferably, the quantity of carrageenan is less than or equal to 0.7% by weight compared with the total weight of the wet receiving layer. The ink-receiving layer comprises from 25 to 80% solids by weight of polysaccharide, more preferably, from 28 to 66% solids by weight of polysaccharide. Preferably, the ink-receiving layer comprises between 0.07% and 3% by weight of polymer comprising hydroxyl groups compared with the total weight of the wet receiving layer. The ink-receiving layer comprises from 5 to 70% by weight of polymer comprising hydroxyl groups, more preferably, from 7 to 61% by weight of polymer comprising hydroxyl groups.

The material intended for forming images by inkjet printing according to the invention can comprise, besides the ink-receiving layer described above, other layers having other functions, arranged above or below said ink-receiving layer. The ink-receiving layer as well as the other layers can comprise any other additives known to those skilled in the art to improve the properties of the resulting image, such as, for example, UV ray absorbers, optical brightening agents, antioxidants, and plasticizers.

In accordance with the manufacturing method of the invention for a material intended for inkjet printing, the composition of the coating intended to form the ink-receiving layer is produced by mixing the carrageenan and the polymer comprising hydroxyl groups, and then by heating the composition to obtain a solution. The composition can also include inorganic receivers, such as silicas, boehmites, aluminosilicates, and a surfactant to improve its coating properties. The composition is then coated on the support according to any appropriate coating method, such as blade, knife, curtain or meniscus coating. The composition is applied with a thickness between approximately 100 μm and 300 μm in the wet state. The composition forming the ink-receiving layer can be applied to both sides of the support. It is also possible to provide an antistatic or anti-roll layer on the back of the support coated with the ink-receiving layer.

In accordance with the present invention, the resulting material is cooled to obtain gelation of the composition coated on the support. Preferably, cooling takes place immediately after the coating step and causes the immediate gelation of the composition coated on the support intended to form the ink-receiving layer.

Then, the resulting material is dried. Because of the gelation and the setting of the composition intended to form the ink-receiving layer, the material can be dried in a dryer in which the supports run vertically (loop dryer), which enables the drying speed to be increased, and thus productivity.

The use of carrageenan enables the composition intended to form the ink-receiving layer to be fixed quickly on the support after coating, while giving it a low enough viscosity at the coating temperature to spread in the coating device. Furthermore, the setting of the composition intended to form the ink-receiving layer before drying enables an ink-receiving layer having great surface uniformity to be obtained. The printed image is thus high-quality. As the material according to the invention has good adhesion properties between the receiving layer and the support, it is no longer necessary to use hardeners. The combination of carrageenan and polymer with hydroxyl groups advantageously enables replacement of the gelatin generally used as binder in the ink-receiving layers of inkjet printing paper and which has the disadvantage of swelling in contact with ink drops. The material intended for forming inkjet-printing images according to the invention has good colorfastness over time. It can be used for any type of inkjet printer as well as for all the inks developed for this technology.

### EXAMPLES

The following examples illustrate the present invention without however limiting its scope.

1) Preparing Compositions Intended to be Coated on a Support to Constitute an Ink-Receiving Layer

Polyvinyl alcohol (PVA) Gohsenol GH23 marketed by Nippon Goshei (hydrolysis rate 87-89%), polyvinylpyrrolidone (PVP) marketed by Aldrich (molecular weight 55,000, reference 856568) and guar gum Viscogum BCR 13/80 marketed by Degussa were used as the polymer comprising hydroxyl groups.

Various carrageenans marketed by Degussa were used:

Satiagel ME5: pure k-carrageenan Satiagel AMP 45: mixture of k-carrageenan and i-carrageenan (approx. 95/5)

Satiagel SIA: pure i-carrageenan

For comparison, a pure l-carrageenan, Satiagum UTC 30, and another polysaccharide, xanthan gum Satiaxane CX 90 marketed by Degussa, were used.

Different compositions were prepared comprising 0.7% by weight of carrageenan, and 1.5% or 3% by weight of PVA or 0.07% by weight of guar gum.

Composition 1:

68 ml of deionized water were added to 23.5 g of a solution of Satiagel ME5 at 3% by weight, with magnetic stirring and heating at 60° C. 7 g of a solution of Viscogum at 1% by weight were added, and the mixture was stirred for 15 min. To improve the uniformity of the coating 1.5 g of surfactant solution 10G marketed by Olin at 20% by weight were introduced. The mixture was cooled at ambient temperature. It was made up with enough deionized water to obtain 100 g of mixture.

Composition 2:

58.5 ml of deionized water were added to 23.5 g of a solution of Satiagel ME5 at 3% by weight, with magnetic stirring and heating at 60° C. 16.5 g of a solution of PVA at 9% by weight were added, and the mixture was stirred for 30 min. To improve the uniformity of the coating, 1.5 g of surfactant solution 10G at 20% by weight were introduced. The mixture was cooled at ambient temperature. It was made up with enough deionized water to obtain 100 g of mixture.

Composition 3:

59 ml deionized water were added to 23.5 g of a solution of Satiagel ME5 at 3% by weight, with magnetic stirring and heating at 60° C. 16.5 g of a solution of PVP at 9% by weight were added, and the mixture was stirred for 30 min. To improve the uniformity of the coating, 1.5 g of surfactant solution 10G at 20% by weight were introduced. The mixture was cooled at ambient temperature. It was made up with enough deionized water to obtain 100 g of mixture.

Composition 4:

61 ml of deionized water were added to 23.5 g of a solution of Satiagel AMP45 at 3% by weight, with magnetic stirring and heating at 60° C. 7 g of a solution of Viscogumυ at 1% by weight were added, and the mixture was stirred for 15 min. 7 g of a solution of potassium chloride at 1% by weight were then added. To improve the uniformity of the coating, 1.5 g of surfactant solution 10G at 20% by weight were introduced. The mixture was cooled at ambient temperature. It was made up with enough deionized water to obtain 100 g of mixture.

Composition 5:

51 ml of deionized water were added to 23.5 g of a solution of Satiagel AMP45 at 3% by weight, with magnetic stirring and heating at 60° C. 16.5 g of a solution of PVA at 9% by weight were added, and the mixture was stirred for 30 min. 7 g of a solution of potassium chloride at 1% by weight were then added. To improve the uniformity of the coating, 1.5 g of surfactant solution 10G at 20% by weight were introduced. The mixture was cooled at ambient temperature. It was made up with enough deionized water to obtain 100 g of mixture.

Composition 6:

68 ml of deionized water were added to 23.5 g of a solution of Satiagel SIA at 3% by weight, with magnetic stirring and heating at 60° C. 7 g of a solution of Visogum™ at 1% by weight were added, and the mixture was stirred for 15 min. To improve the uniformity of the coating, 1.5 g of surfactant solution 10G at 20% by weight were introduced. The mixture was cooled at ambient temperature. It was made up with enough deionized water to obtain 100 g of mixture.

Composition 7:

58 ml of deionized water were added to 23.5 g of a solution of Satiagel SIA at 3% by weight, with magnetic stirring and heating at 60° C. 16.5 g of a solution of PVA at 9% by weight were added, and the mixture was stirred for 30 min. To improve the uniformity of the coating, 1.5 g of surfactant solution 10G at 20% by weight were introduced. The mixture was cooled at ambient temperature. It was made up with enough deionized water to obtain 100 g of mixture.

Composition 8:

58 ml of deionized water were added to 23.5 g of a solution of Satiagel UTC 30 at 3% by weight, with magnetic stirring and heating at 60° C. 16.5 g of a solution of PVA at 9% by weight were added, and the mixture was stirred for 30 min. To improve the uniformity of the coating, 1.5 g of surfactant solution 10G at 20% by weight were introduced. The mixture was cooled at ambient temperature. It was made up with enough deionized water to obtain 100 g of mixture.

Composition 9:

52 ml of deionized water were added to 11.75 g of a solution of Satiagel™ CX 90 at 3% by weight, with magnetic stirring and heating at 60° C. 35 g of a solution of Visogum™ at 1% by weight were added, and the mixture was stirred for 15 min. To improve the uniformity of the coating, 1.5 g of surfactant solution 10G at 20% by weight were introduced. The mixture was cooled at ambient temperature. It was made up with enough deionized water to obtain 100 g of mixture.

Composition 10:

65 ml of deionized water were added to 33.33 g of a solution of PVA at 9% by weight, with magnetic stirring and heating at 60° C. To improve the uniformity of the coating, 1.5 g of surfactant solution 10G at 20% by weight were introduced. The mixture was cooled at ambient temperature. It was made up with enough deionized water to obtain 100 g of mixture.

Composition 11:

65 ml of deionized water were added to 33.33 g of a solution of PVA at 9% by weight, with magnetic stirring and heating at 60° C. 180 mg of 1-4 dioxane-2,3 diol (DHD) and 50 mg boric acid were added with stirring. To improve the uniformity of the coating, 1.5 g of surfactant solution 10G at 20% by weight were introduced. The mixture was cooled at ambient temperature. It was made up with enough deionized water to obtain 100 g of mixture.

Composition 12:

29 ml of deionized water were added to 70 g of a solution of Visogum™ at 1% by weight, with magnetic stirring and heating at 60° C. To improve the uniformity of the coating, 1.5 g of surfactant solution 10G at 20% by weight were introduced. The mixture was cooled at ambient temperature. It was made up with enough deionized water to obtain 100 g of mixture.

Composition 13:

29 ml of deionized water were added to 70 g of a solution of Visogum™ at 1% by weight, with magnetic stirring and heating at 60° C. 16.5 g of a solution of PVA at 9% by weight were added, and the mixture was stirred for 15 min. To improve the uniformity of the coating, 1.5 g of surfactant solution 10G at 20% by weight were introduced. The mixture was cooled at ambient temperature. It was made up with enough deionized water to obtain 100 g of mixture.

Composition 14:

68 ml of deionized water were added to 23.5 g of a solution of Satiagel ME5 at 3% by weight, with magnetic stirring and heating at 60° C. To improve the uniformity of the coating, 1.5 g of surfactant solution 10G at 20% by weight were introduced. The mixture was cooled at ambient temperature. It was made up with enough deionized water to obtain 100 g of mixture.

Composition 15:

68 ml of deionized water were added to 23.5 g of a solution of Satiagel AMP 45 at 3% by weight, with magnetic stirring and heating at 60° C. To improve the uniformity of the coating, 1.5 g of surfactant solution 10G at 20% by weight were introduced. The mixture was cooled at ambient temperature. It was made up with enough deionized water to obtain 100 g of mixture.

Composition 16:

60 ml of deionized water were added to 23.5 g of a solution of Satiagel ME5 at 3% by weight, with magnetic stirring and heating at 60° C. 16.7 g of a solution of polyvinyl pyrrolidone at 9% by weight was added and the mixyure was stirred for 30 minutes. The polyvinyl pyrrolidone was supplied by Aldrich (mw=55,000, reference 85,656-8). To improve the uniformity of the coating, 1.5 g of surfactant solution 10G at 20% by weight were introduced. The mixture was cooled at ambient temperature. It was made up with enough deionized water to obtain 100 g of mixture.

The viscosity of the compositions at 60° C. was measured using Visco Star-L equipment marketed by Fungilab S.A. (shear rate 100-200 rpm). The evolution of the behavior of the compositions was also observed while letting them cool at ambient temperature (25° C.). The results are given in Table I below. The percentages are percentages by weight.

TABLE I

| | | Viscosity | |
|---|---|---|---|
| Composition | Gel | (mPa · s−1) | Gel characteristics |
| Composition 1 | +++ | 10 | No syneresis |
| Composition 2 | +++ | 17 | No syneresis |
| Composition 3 | ++ | | No syneresis |
| Composition 4 | +++ | 17 | No syneresis |
| Composition 5 | +++ | 30 | No syneresis |
| Composition 6 | ++ | 31 | No syneresis |
| Composition 7 | ++ | 39 | No syneresis |
| Composition 8 | — | — | No gel formation |
| Composition 9 | ++ | 36 | No syneresis |
| Composition 10 | − | 6.6 | No gel formation |
| Composition 11 | − | 5.5 | No gel formation |
| Composition 12 | − | 40 | No gel formation |
| Composition 13 | − | 13 | Demixing, no gel |
| Composition 14 | + | 26 | Syneresis |
| Composition 15 | + | 25 | Syneresis |
| Composition 16 | ++ | 10 | No syneresis, soft gel |

+++ indicates the formation of a strong gel
++ indicates the formation of a light gel
+ indicates the formation of a very light gel
− indicates no gel formation

The above results show that only carrageenans, and in particular kappa and iota carrageenans, enable a gel to be obtained. Compositions comprising a majority of kappa carrageenans have a stronger gel than those comprising only iota carrageenans. The syneresis phenomena observed with the use of carrageenans alone is eliminated with the use of a polymer comprising hydroxyl groups.

2) Preparing Materials Intended for Forming Images by Inkjet Printing

A Resin Coated Paper type support, previously coated with a very thin gelatin layer and having undergone prior Corona discharge treatment, was placed on a coating machine and held on the machine by vacuum. This support was coated with a composition as prepared according to section 1 and previously heated to 60° C. using a bar with a wet thickness of 200 μm. The coating conditions are given in Table II below:

TABLE II

| Parameters | Values | |
|---|---|---|
| Coating speed | 0.3 | ms−1 |
| Wet thickness | 200 | μm |
| Coated area | 630 | cm² |
| Setting temperature | 15° | C. |
| Volume of coated composition | 20 | ml |
| Temperature of the composition | 60° | C. |

The resulting materials correspond to the examples, shown in Table III below, specifying the polysaccharide and the polymer with hydroxyl groups used in the ink-receiving layer:

TABLE III

| | | Polysaccharide or | Polymer with | Gloss |
|---|---|---|---|---|
| Example | Composition | other | hydroxyl group | (60°) |
| 1 (inv.) | 1 | k-carrageenan | Guar gum | 26 |
| 2 (inv.) | 2 | k-carrageenan | PVA | 32 |
| 3 (comp.) | 3 | k-carrageenan | PVP | |
| 4 (inv.) | 4 | k-carrageenan/i- | Guar gum | 30 |
| | | carrageenan | | |
| 5 (inv.) | 5 | k-carrageenan/i- | PVA | 40 |
| | | carrageenan | | |
| 6 (inv.) | 6 | i-carrageenan | Guar gum | 35 |
| 7 (inv.) | 7 | i-carrageenan | PVA | 55 |
| 8 (comp.) | 9 | Xanthan | Guar gum | 29 |
| 9 (comp.) | 10 | — | PVA | 88 |
| 10 (comp.) | 11 | DHD and boric | PVA | 90 |
| | | acid | | |
| 11 (comp.) | 12 | — | Guar gum | 55 |
| 12 (comp.) | 13 | — | Guar gum/PVA | 55 |
| 16 (comp.) | 16 | k-carageenan | PVP | 74 |

All the materials according to the invention have fast setting and good adhesion properties between the ink-receiving layer and the support. Consequently, the ink-receiving layer is uniform and the materials according to the invention can be dried in loop dryers. However, the materials comprising only polymers with hydroxyl groups do not set. This means that the ink-receiving layer is not uniform. The combination of PVA with a crosslinking agent (DHD+boric acid) enables the uniformity of the layer to be improved, but there is no gel formation, thus no setting. Thus the material cannot be dried in a loop drier. Also measured was the gloss of the resulting materials, using a Picogloss 560 glossmeter marketed by Erichsen.

The results given in Table III show that PVA enables the best gloss to be obtained and the guar gum gives a satin appearance. Furthermore, the gloss increased as the amount of iota type carrageenans increased.

3) Evaluating the Printing Properties

Test charts were printed on the resulting materials using a HP Deskjet 5550 inkjet printer. The printing properties evaluated were drying speed, image definition, faults such as abrasion, the formation of stripes, and lateral spread of the dye and ink coalescence.

The drying speed (VS) was measured just after the printing of a tested material, using a sheet of paper (size A4, basis weight 80 g), which is directly applied to the printed material. A roller (weight 2 kg, L=18.5 cm, f=4 cm) was applied to the sheet of paper.

A qualitative assessment of the degree of color transfer on the sheet of paper was made: 1=no transfer, 2=slight colored marks but impossible to detect image features, 3=at least two colors identified and possible to detect image features, 4=at least three colors identified and 60-70% of the image reproduced on the sheet of paper, 5=all the colors identified and at least 80% of the image reproduced on the sheet of paper.

Image definition (Def) was assessed according to three degrees: High (H)=perfect reproduction of the image features, Medium (M)=slight degradation of the image based on the phenomenon of lateral dye spread (low to medium) or coalescence (low to high), Low (F)=significant degradation of the image due to hazy colors (significant lateral dye spread, significant dispersion). The faults are image degradation phenomena: A=abrasion caused by the printer by marks or partial delamination; Ba=formation of stripes causing visible differences of the pattern instead of a gradual color transition, Dl=lateral dye spread corresponding to ink spread, C=ink coalescence, with three degrees High, Medium, Low.

Touch sensitivity (SD) was measured one hour after printing, and was evaluated by simple observation under exposure to slanting light.

The results are given in Table IV below:

TABLE IV

| Example | VS | Def | Fault | SD |
|---|---|---|---|---|
| 1 (inv.) | 3 | M | C(L) | No |
| 2 (inv.) | 1 | H | No | No |
| 3 (comp.) | 3 | H | No | No |
| 4 (inv.) | 2 | H | No | No |
| 5 (inv.) | 1 | H | No | No |
| 6 (inv.) | 5 | M | C(M) | No |
| | | | Dl(M) | |
| 7 (inv.) | 3 | H | No | No |
| 8 (comp.) | 4 | H | Dl(L) | No |
| 9 (comp.) | 3 | H | No | Yes |
| 10 (comp.) | 3 | L | C(H) | Yes |
| | | | Ba(H) | |
| 11 (comp.) | 5 | M | C(M) | Yes |
| | | | A(M) | |
| | | | Dl(L) | |
| 12 (comp.) | 2 | H | Dl(L) | No |
| | | | A(H) | |
| 16 (comp.) | 3 | H | No | No |

The results of Table IV show that only the kappa and/or iota type carrageenans in combination with polymers comprising hydroxyl groups enable materials for inkjet printing to be obtained with good image definition, good drying speeds, especially when PVA is used. Furthermore, kappa and/or iota type carrageenans in combination with polymers comprising hydroxyl groups enable materials for inkjet printing to be obtained with good mechanical properties, such as good adhesion to the support, no tendency to crackle, and no tendency to roll-up.

4) Evaluating Colorfastness Over Time

To evaluate colorfastness over time, a color alteration test by exposure to ozone was performed for each resulting material. Test charts, comprising four colors (black, yellow, cyan and magenta), were printed on each material using a HP 5550 printer and related ink. The test charts were analyzed using a GretagMacbeth Spectrolino densitometer that measures the strength of the various colors. Then, the materials were placed in the dark in a room with controlled ozone atmosphere (60 ppb) for three weeks. Each week, any degradation of the color density was monitored using the densitometer.

Also, for the resulting materials, a color alteration test was carried out by exposure to light of 50 Klux for two weeks. Test charts, comprising four colors (black, yellow, cyan and magenta) were printed on the resulting materials using a HP 5550 printer and the related ink. Then, the printed test charts were placed under a sheet of Plexiglas 6 mm thick and totally transparent to the emission spectra of the neon tubes used (Osram Lumilux FQ 80 W/840 Cool White), in order to minimize atmospheric oxidation phenomena. Any deterioration of the color density was measured using the densitometer after two weeks.

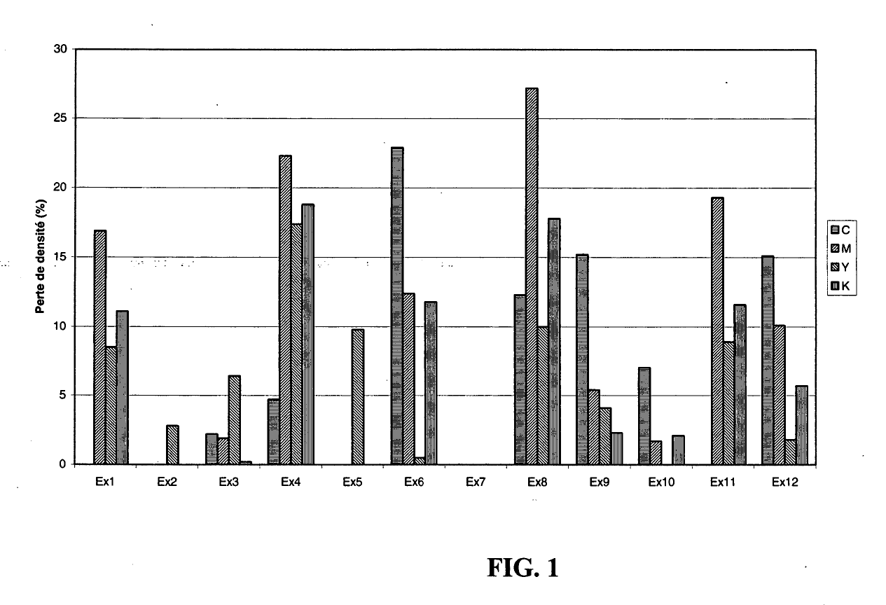

FIG. 1 represents the percentage of density loss observed for the maximum density for the four colors of the test chart after three weeks for examples 1 to 12 printed and exposed to ozone. Letters K, C, M and Y represent the colors black, cyan, magenta and yellow respectively. No bar means that the density loss was 0%.

It may be noted that the materials according to the invention (Examples 1 to 7) combining kappa and/or iota type carrageenans with polymers comprising hydroxyl groups have greater stability to ozone and thus better colorfastness than the comparative materials. The materials of the invention (Examples 2, 5 and 7) using PVA are particularly efficient.

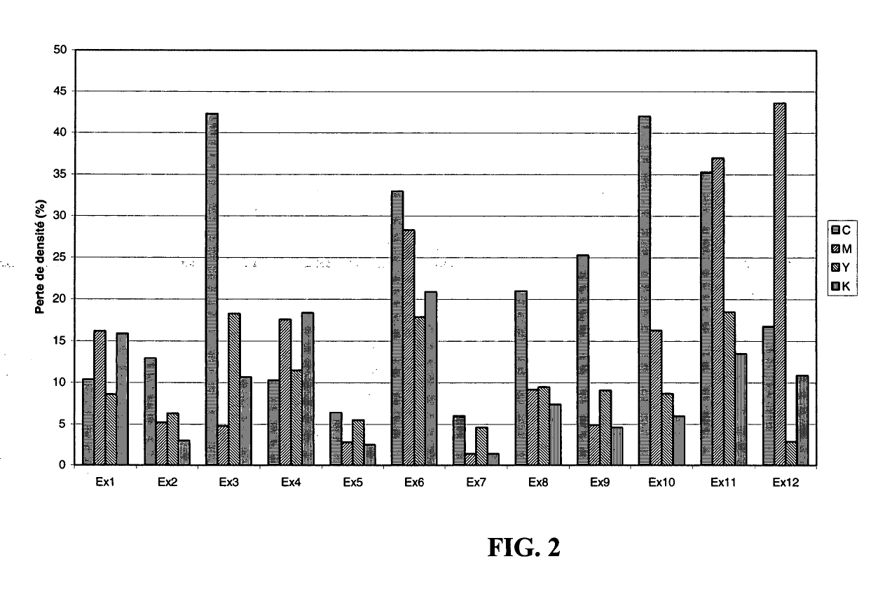

FIG. 2 represents the percentage of density loss observed for the maximum density for the four colors of the test chart after two weeks for examples 1 to 12 printed and exposed to ozone. It may be noted that the materials according to the invention (Examples 1 to 7) combining kappa and/or iota type carrageenans with polymers comprising hydroxyl groups have greater stability to light and thus better colorfastness than the comparative materials. The materials of the invention (Examples 2, 5 and 7) using PVA are particularly efficient.

The invention has been described in detail with particular reference to certain preferred embodiments thereof, but it will be understood that variations and modifications can be effected within the spirit and scope of the invention.

1. A material intended for forming images by inkjet printing, comprising a support and at least one ink-receiving layer, wherein said ink-receiving layer comprises at least one polysaccharide and at least one polymer comprising hydroxyl groups.

2. The material of claim 1 wherein said polysaccharide comprises carrageenan.

3. The material of claim 2 wherein said carrageenan is selected from the group consisting of the κ-carrageenans, the ι-carrageenans and a mixture of these compounds.

4. The material of claim 2 wherein said carrageenan comprises at least 80% of κ-carrageenan.

5. The material of claim 2 wherein said carrageenan is a pure κ-carrageenan.

6. The material of claim 1 wherein said polymer comprising the hydroxyl groups is selected from among the group consisting of polyvinyl alcohol, guar gum, and a mixture of these polymers.

7. The material of claim 1 wherein said ink-receiving layer comprises at least 1% by weight of polysaccharide compared with the total weight of the wet receiving layer.

8. The material of claim 1 wherein said ink-receiving layer comprises from 25 to 80% solids by weight of polysaccharide.

9. The material of claim 1 wherein said ink-receiving layer comprises from 28 to 66% solids by weight of polysaccharide.

10. The material of claim 1 wherein said ink-receiving layer comprises between 0.07% and 3% by weight of polymer comprising hydroxyl groups compared with the total weight of the wet receiving layer.

11. The material of claim 1 wherein said ink-receiving layer comprises from 5 to 70% by weight of polymer comprising hydroxyl groups.

12. The material of claim 1 wherein said ink-receiving layer comprises from 7 to 61% by weight of polymer comprising hydroxyl groups.

13. The material of claim 1 wherein said at least one polymer comprising hydroxyl groups is water soluble.

14. A method of manufacturing a material intended for forming images by inkjet printing comprising:
a) heating a composition intended to form the ink-receiving layer, wherein said composition comprises at least one carrageenan and at least one polymer comprising hydroxyl groups, to obtain a solution,
a) coating said composition on a support,
c) cooling the resulting material to obtain the thermoreversible gelation of the composition,
d) drying the material.
